(19) United States
(12) Patent Application Publication
(10) Pub. No.: US 2008/0204377 A1
(43) Pub. Date: Aug. 28, 2008

(54) Organic EL display device

(76) Inventors: Kenta Kajiyama, Mobara (JP); Naoki Tokuda, Mobara (JP); Hiroshi Kageyama, Hachioji (JP)

Correspondence Address: REED SMITH LLP, Suite 1400, 3110 Fairview Park Drive, Falls Church, VA, 22042, US

(21) Appl. No.: 12/071,775

(22) Filed: Feb. 26, 2008

(30) Foreign Application Priority Data
Feb. 28, 2007 (JP) 2007-048998

(51) Int. Cl. G09G 3/30

(52) U.S. Cl. 345/76

(57) ABSTRACT

The present invention realizes a high-quality display by optimizing a light emitting efficiency among pixels which differ in light emitting characteristic from each other by enabling to apply voltages corresponding to pixels which differ in color from each other while suppressing brightness irregularities attributed to a voltage drop of a power source line. Only power source lines Lv of sub pixels B and a bypass line Lb are connected with each other in a first row (X1), only power source lines Lv of sub pixels R and a bypass line Lb are connected with each other in a second row (X2), and only power source lines Lv of sub pixels G and a bypass line Lb are connected with each other in a third row (X3). Then, these arrangements of the sub pixels B, R, G, the power source lines Lv and the bypass lines Lb are repeated.

### CLAIM OF PRIORITY

The present application claims priority from Japanese Application JP 2007-48998 filed on Feb. 28, 2007, the content of which is hereby incorporated by reference into this application.

### BACKGROUND OF THE INVENTION

1. Field of the Invention

The present invention relates to an organic EL display device having organic light emitting elements, and more particularly to an organic EL display device which can reduce the non-uniformity of brightness attributed to lowering of a voltage of power source lines which supply an electric current to pixels.

2. Description of the Related Art

The organic EL display device (hereinafter also referred to as organic EL display) is driven with supply of an electric current, wherein a plurality of pixels which are arranged in parallel to each other are connected to a power source line. Accordingly, voltages applied to the pixels differ from each other depending on positions where the pixels are connected with the power source lines thus causing non-uniformity of brightness within a display screen. The larger a screen size of the organic EL display device, the larger the electric current which flows into the power source line becomes and hence, a voltage drop between the pixels is increased depending on locations where the pixels are arranged whereby the display irregularities attributed to brightness irregularities are also increased.

FIG. 12 is a plan view of an essential part of a display region for explaining an example of arrangement of pixels in an organic EL display device. Further, FIG. 13 is an enlarged view showing two neighboring pixels in FIG. 12. Here, in performing color display, one color pixel (pixel) is constituted of a plurality of sub pixels which display a plurality of primary colors. For example, in FIG. 12, unit pixels indicated by R (red), G (green), B (blue) constitute the sub pixels and light emitting portions of these sub pixels are indicated by pr, pg, pb. Here, for facilitating the explanation of the organic EL display device, unless otherwise necessary to particularly specify the sub pixels, the sub pixels may be simply referred to as pixels. In FIG. 12, symbols X1, X2, . . . indicate rows, while symbols Y1, Y2, . . . indicate columns.

FIG. 12 and FIG. 13 show the organic EL display device having the active matrix constitution which adopts the three-color stripe arrangement consisting of R (red), G (green) and B (blue). In general, one sub pixel is constituted of a power source line Lv which functions as the power source supply line, a data signal line Ld which supplies a video signal, a scanning signal line Ls which selects the row to which the data is written, a pixel circuit pc which is constituted of a thin film transistor and a data holding capacitance, and a light emitting portion pL which is formed of an organic EL light emitting layer (in FIG. 12, the pixel circuit pc and the light emitting portion pL being collectively indicated). The light emitting portion pL may be constituted of any one of the light emitting portion pr of the sub pixel of R, the light emitting portion pg of the sub pixel of G, and the light emitting portion pb of the sub pixel of B.

As means for reducing the above-mentioned display irregularities, a method which connects neighboring power source lines is disclosed in patent document 1 (JP-A-2000-242196), patent document 2 (JP-A-2001-100654), and patent document 3 (JP-A-2004-356052). Patent document 1 discloses the constitution which suppresses a voltage drop by providing a power source bypass line which intersects the power source lines and connecting all power source lines by the power source bypass line. Patent document 2 discloses the invention which suppresses a voltage drop by forming a light-blocking black matrix using a material having low resistance and by connecting all power sources to the black matrix. Further, patent document 3 discloses the constitution which suppresses lowering of a numerical aperture of pixels while suppressing a voltage drop by arranging power source bypass lines only in specific pixels. Although not explicitly described in patent document 3, this document suggests the application of a voltage for respective pixels which differ in color.

FIG. 14 is a plan view of an essential part of a display region for explaining an example of the constitution of a conventional organic EL display device having power source bypass lines. Further, FIG. 15 is an enlarged view showing two neighboring pixels of FIG. 14. FIG. 14 and FIG. 15 show the organic EL display device disclosed in patent document 1, and the arrangement of rows and columns and the arrangement of the sub pixels are equal to the corresponding arrangements shown in FIG. 12. In this constitutional example, the neighboring power source lines Lv are connected with each other by the power source bypass line Lb thus providing the mesh-shaped power source supply structure.

### SUMMARY OF THE INVENTION

In the inventions disclosed in patent document 1 and patent document 2, the power source voltages cannot be applied for respective pixels which differ in color from each other. Patent document 3 fails to explicitly describe specific means for applying different power source voltages corresponding to respective pixels which differ in color from each other. Although the invention described in patent document 3 may increase a numerical aperture of the pixels, sizes of the pixels are not uniform and hence, there exists the possibility that the pixels having the small numerical aperture appear dark. On the other hand, in an attempt to make the numerical apertures of the pixels equal to each other, the centers of the neighboring pixels are displaced from each other thus necessitating the correction on a video signal side.

It is an object of the present invention to realize a high-quality display by optimizing a light emitting efficiency between pixels which differ in light emitting characteristic from each other by enabling the application of voltages corresponding to pixels which differ in color from each other while suppressing brightness irregularities attributed to a voltage drop of a power source line.

An organic EL display device of the present invention includes an insulation substrate having a display region in which color pixels are arranged in a matrix array and each one color pixel is constituted of a plurality of organic EL elements which constitute sub pixels and emit light different from each other, and a transparent sealing substrate which is arranged to cover the display region, wherein lights emitted from the color pixels each consisting of the sub pixels are radiated from a sealing substrate side. However, the present invention is also applicable, in the same manner, to an organic EL display device which is configured to emit lights of color pixels from an insulation substrate side. Typical constitutional features of the present invention are as follows.

In the present invention, a plurality of scanning signal lines extending in one direction and arranged in parallel to each other in another direction which intersects the one direction, a plurality of data signal lines extending in the another direction and arranged parallel to each other in the one direction, and a plurality of power source lines which are connected to the plurality of sub pixels and to which an electric current for display is supplied are arranged in the display region, the sub pixels are arranged corresponding to intersecting portions of the scanning signal lines and the data signal lines, the display region includes a plurality of power source bypass lines extending in the one direction and arranged in parallel to each other in the another direction, and one, two or more power source bypass lines are connected only to the power source lines connected to the sub pixels of one color out of the power source lines.

In the present invention, the one color pixel includes the sub pixels of red, green and blue, and the bypass lines include the bypass lines which are connected with only the sub pixels of red, the bypass lines which are connected with only the sub pixels of green, and the bypass lines which are connected with only the sub pixels of blue.

In the present invention, the one color pixel includes the sub pixels of white, and the display device includes the bypass lines which are connected with only the sub pixels of white as the bypass lines.

Further, in the present invention, to cope with stripe-shaped irregularities attributed to the continuous arrangement of contact portions between the power source lines and the bypass lines within the display region, following technical features are provided.

(1) The bypass line is provided for every scanning signal line.

(2) A connection pattern formed on one or both of the power source bypass lines and the power source lines is provided to intersecting portions between the power source bypass lines and the power source lines, and either one or both of a line width of the power source bypass line and a line width of the power source line is/are set equal to or larger than a width of the connection pattern.

(3) The connection patterns include dummy connection patterns which do not contribute to the connection between the power source bypass lines and the power source lines.

(4) The connection pattern consisting of five or more continuous pixels is not formed in the oblique linear direction on the matrix of the sub pixels.

It is needless to say that the present invention is not limited to the above-mentioned respective constitutions and the constitutions of preferred embodiments described later and various modifications are conceivable without departing from the technical concept of the present invention.

According to the present invention, with the increase of a wiring area, the wiring resistance is reduced and hence, a voltage drop can be also suppressed whereby the uniformity of brightness is enhanced. Further, since the power source lines have midst portions thereof connected with each other, the generation of smears can be suppressed. By providing the bypass line dedicated to every group of pixels (sub pixels) of the same color, power source voltages which differ from each other corresponding to the pixels of different colors can be supplied. Further, by properly arranging the connection points (contacts) between the power source lines and the bypass lines, it is possible to make the reflection irregularities inconspicuous in the oblique direction at the contacts.

### BRIEF DESCRIPTION OF THE DRAWINGS

FIG. 1 is a plan view of an essential part of a display region for explaining an embodiment 1 of an organic EL display device according to the present invention;

FIG. 2 is an enlarged view showing two neighboring pixels of FIG. 1;

FIG. 3 is an enlarged view showing two neighboring pixels of FIG. 1 for explaining an embodiment 2 of an organic EL display device according to the present invention;

FIG. 4 is an enlarged view showing two neighboring pixels of FIG. 1 for explaining an embodiment 3 of an organic EL display device according to the present invention;

FIG. 5 is a plan view of an essential part of a display region for explaining an embodiment 4 of an organic EL display device according to the present invention;

FIG. 6 is a plan view of an essential part of a display region for explaining an embodiment 5 of an organic EL display device according to the present invention;

FIG. 7 is a plan view of an essential part of a display region for explaining an embodiment 6 of an organic EL display device according to the present invention;

FIG. 8 is a plan view of an essential part of a display region for explaining an embodiment 7 of an organic EL display device according to the present invention;

FIG. 9 is an enlarged view showing neighboring four pixels of FIG. 8;

FIG. 10A and FIG. 10B are views for explaining one example of the pixel structure of a top-emission-type organic EL display device according to the present invention;

FIG. 11 is an equivalent circuit diagram for explaining an overall constitutional example of the organic EL display device according to the present invention;

FIG. 12 is a plan view of an essential part of the display region for explaining an example of arrangement of pixels of the organic EL display device;

FIG. 13 is an enlarged view showing two neighboring pixels of FIG. 12;

FIG. 14 is a plan view of an essential part of the display region for explaining an example of the constitution of a conventional organic EL display device having a power source bypass line; and

FIG. 15 is an enlarged view showing two neighboring pixels of FIG. 14.

### DESCRIPTION OF THE PREFERRED EMBODIMENTS

Hereinafter, preferred embodiments of an organic EL display device according to the present invention are explained in detail in conjunction with drawings showing the respective embodiments.

### Embodiment 1

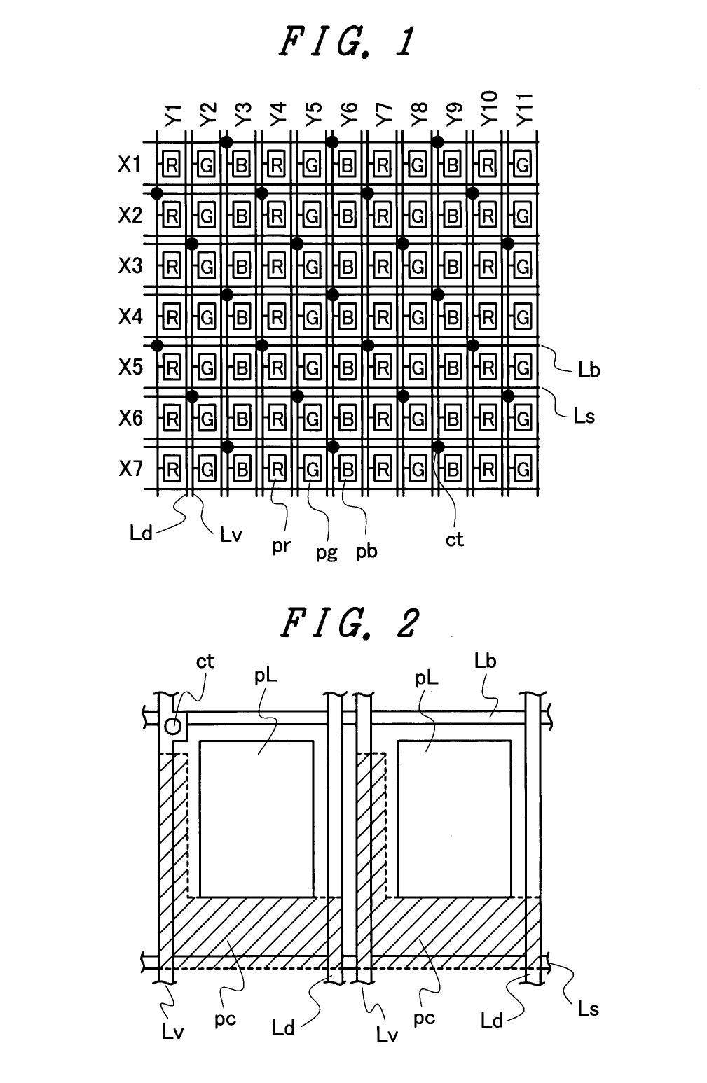

FIG. 1 is a plan view of an essential part of a display region for explaining an embodiment 1 of an organic EL display device according to the present invention. Further, FIG. 2 is an enlarged view showing two neighboring pixels of FIG. 1. In FIG. 1, only power source lines Lv of sub pixels B and a bypass line Lb are connected with each other in a first row (X1), only power source lines Lv of sub pixels R and a bypass line Lb are connected with each other in a second row (X2), and only power source lines Lv of sub pixels G and a bypass line Lb are connected with each other in a third row (X3). Thereafter, these arrangements of the sub pixels B, R, G, the power source lines Lv and the bypass lines Lb are repeated. Due to such a constitution, it is possible to supply power source voltages which differ to each other corresponding to the sub pixels of respective colors.

On a left side in FIG. 2, the sub pixel in which the power source line Lv and the bypass line Lb are connected with each other (having a contact ct) is arranged, and on a right side in FIG. 2, the sub pixel in which the power source line Lv and the bypass line Lb are not connected with each other (having no contact ct) is arranged. By taking a processing margin into consideration, it is necessary to set a width (area) of a portion of a contact ct larger than a minimum line width. The same goes for both of the power source line Lv and the bypass line Lb.

Due to the constitution of the embodiment 1, the power sources can be supplied to the respective sub pixels of red, green, blue and hence, a color balance can be properly adjusted by adjusting current quantities in conformity with light emitting efficiencies of respective colors so as to acquire a display image of high quality.

### Embodiment 2

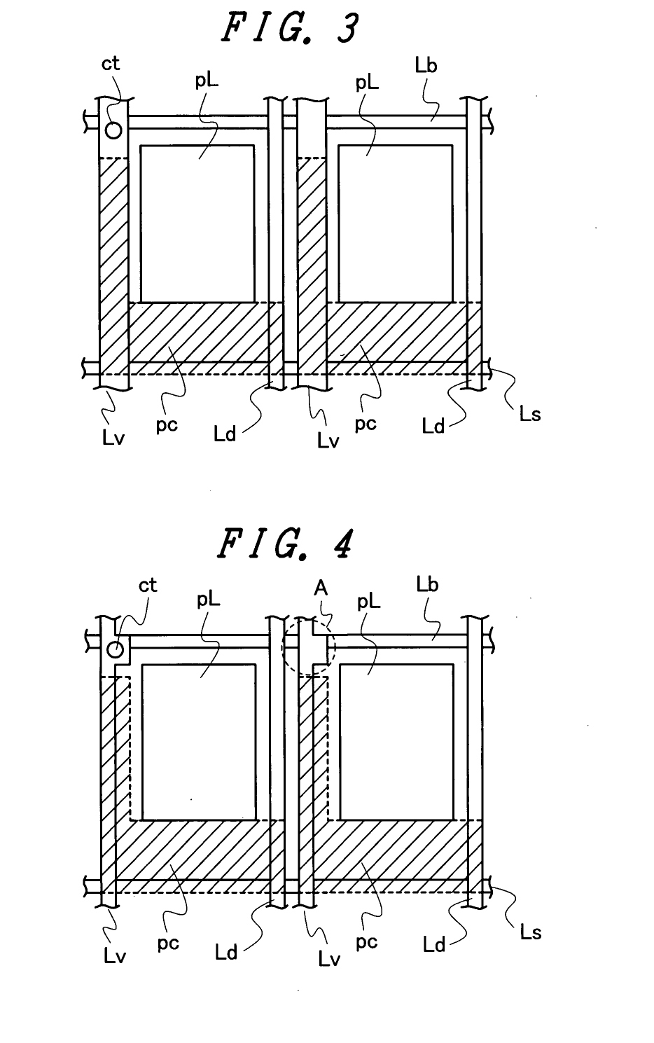

FIG. 3 is an enlarged view showing two neighboring pixels of FIG. 1 for explaining an embodiment 2 of an organic EL display device according to the present invention. In the constitution of the embodiment 1, the pixel having the contact ct increases the reflectance thereof by an amount corresponding to the increase of a pattern width of the contact and hence, the pixels having the high reflectance are continuously arranged in the oblique direction in FIG. 1 (in the direction toward the neighboring pixel by one row and one column) whereby a stripe may appear in the oblique direction. The constitution of the embodiment 2 is provided for suppressing the generation of such a stripe.

In the embodiment 2, a width of the power source line Lv and a width of the bypass line Lb are set equal to or larger than a width of the contact ct thus allowing the pixel having the contact ct and the pixel having no contact ct to possess substantially an equal reflectance. In FIG. 3, although both of the width of the power source line Lv and the width of the bypass line Lb are made large, it is possible to obtain the above-mentioned effect of suppressing the generation of the stripe even when the width of only one of these lines is increased. However, by increasing the width of a line layer closer to a viewer side instead of increasing the width of a line layer remote from the viewer side, it is possible to expect much larger stripe generation suppressing effect.

### Embodiment 3

FIG. 4 is an enlarged view showing two neighboring pixels of FIG. 1 for explaining an embodiment 3 of an organic EL display device according to the present invention. In the same manner as the embodiment 2, the embodiment 3 also adopts the constitution which can suppress the generation of a stripe in the oblique direction. In the embodiment 3, as shown in a portion surrounded by A in FIG. 4, the pixel having no contact ct also has the same line pattern as the pixel having the contact ct. Also in such a constitution, only either one of the power source lines Lv and the bypass lines Lb can have the same pattern, and by making the line layers closer to a viewer side have the same pattern instead of the line layers remote from the viewer side, it is possible to expect much larger stripe generation suppressing effect.

### Embodiment 4

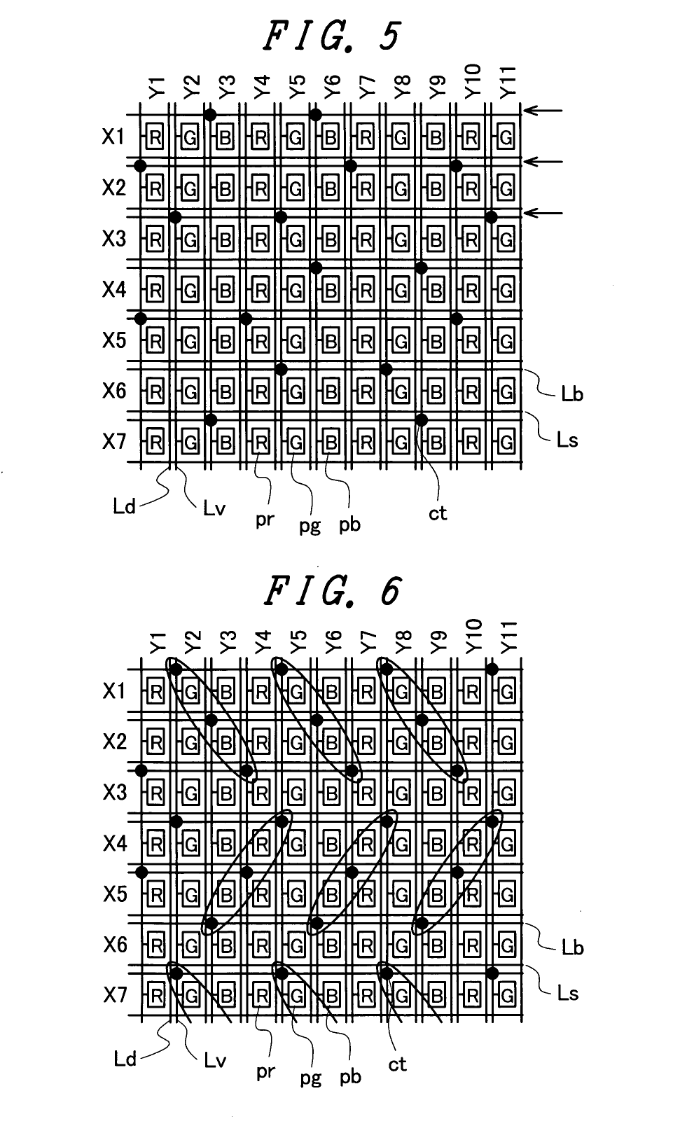

FIG. 5 is a plan view of an essential part of a display region for explaining an embodiment 4 of an organic EL display device according to the present invention. In the same manner as the embodiments 2 and 3, the embodiment 4 also adopts the constitution which can suppress the generation of a stripe in the oblique direction. In the embodiment 4, on the first row (X1), the contacts ct between the power source lines Lv of the sub pixels B and the bypass lines Lb are thinned at a rate of 1 piece per 3 pieces (bringing a state in which one contact ct is eliminated out of three contacts ct). Then, the contact ct on the second row (X2) positioned between two continuous contacts ct on the first row (X1) is thinned (thus bringing a state in which the contact ct is eliminated). The contact ct on the third row (X3) positioned between two continuous contacts ct on the second row (X2) is thinned (thus bringing a state in which the contact ct is eliminated).

Thereafter, by repeating the above-mentioned arrangement, the pixels, the power source lines Lv and the bypass lines Lb are arranged such that three or more contacts ct are not continuously arranged in the oblique direction (in the direction toward the neighboring pixel by one row and one column) or in the neighboring direction (in the lateral direction or in the longitudinal direction). In FIG. 5, the contacts ct are thinned such that three or more contacts ct are not continuously arranged. However, by thinning the contacts ct such that four or more contacts ct are not continuously arranged, it is also possible to have the substantially equal stripe generation suppressing effect. However, as the number of continuous contacts ct becomes large, the possibility that the stripe in the oblique direction appears is increased and hence, the thinning method shown in FIG. 5 is most effective.

### Embodiment 5

FIG. 6 is a plan view of an essential part of a display region for explaining an embodiment 5 of an organic EL display device according to the present invention. In the same manner as the embodiments 2 to 4, the embodiment 5 also adopts the constitution which can suppress the generation of a stripe in the oblique direction. In the embodiment 5, with respect to three sets of bypass lines Lb on the first row (X1), the second row (X2) and the third row (X3), the bypass lines Lb are connected to the power source lines Lv of GBR in the order from above, while with respect to the next three sets of bypass lines Lb on the fourth row (X4), the fifth row (X5) and the sixth row (X6), the bypass lines Lb are connected to the power source lines Lv of GRB in the order from above.

In this manner, by repeatedly arranging two or more kinds of combinations of connection, the continuity of the contacts in the oblique direction (in the direction toward the neighboring pixel by one row and one column) is collapsed and hence, the generation of the stripe in the oblique direction can be suppressed.

Further, it may also be possible to adopt a method which connects the bypass lines Lb of neighboring rows with the power source lines Lv of the sub pixels having the same color. However, in such a method, after the bypass lines Lb are connected with the power source lines Lv continuously in two rows, the bypass lines Lb are not connected with the power source lines Lv continuously in four rows thus giving rise to the possibility that the uniformity of brightness is deteriorated. Accordingly, the arrangement shown in FIG. 6 is preferable.

### Embodiment 6

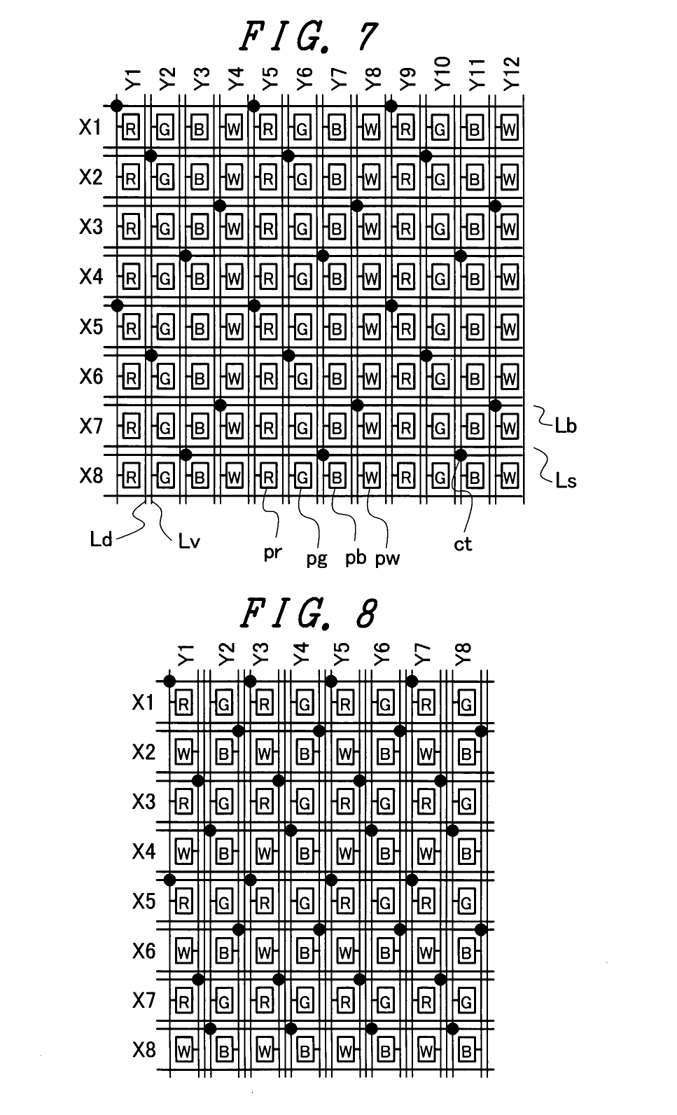

FIG. 7 is a plan view of an essential part of a display region for explaining an embodiment 6 of an organic EL display device according to the present invention. In expressing the above-mentioned full-color display using three colors, even when the order of the sub pixels RGB is changed to R, B, G, the contacts ct are continuously arranged in the oblique direction (in the direction toward the neighboring pixel by one row and one column). However, in expressing the full-color display using four or more colors, it is possible to provide the combination which prevents three or more contacts from being continuously arranged in the oblique direction. In the embodiment 6, the full-color display is expressed by four colors (R, G, B, W), and the sub pixels R, G, B, W are arranged in this order in the lateral direction. In this case, by arranging the connection between the power source line Lv and the bypass line Lb in the order of R, G, W, B from above, three or more contacts are not continuously arranged in the oblique direction (in the direction toward the neighboring pixel by one row and one column). Due to such an arrangement, a stripe in the oblique direction can be hardly observed.

### Embodiment 7

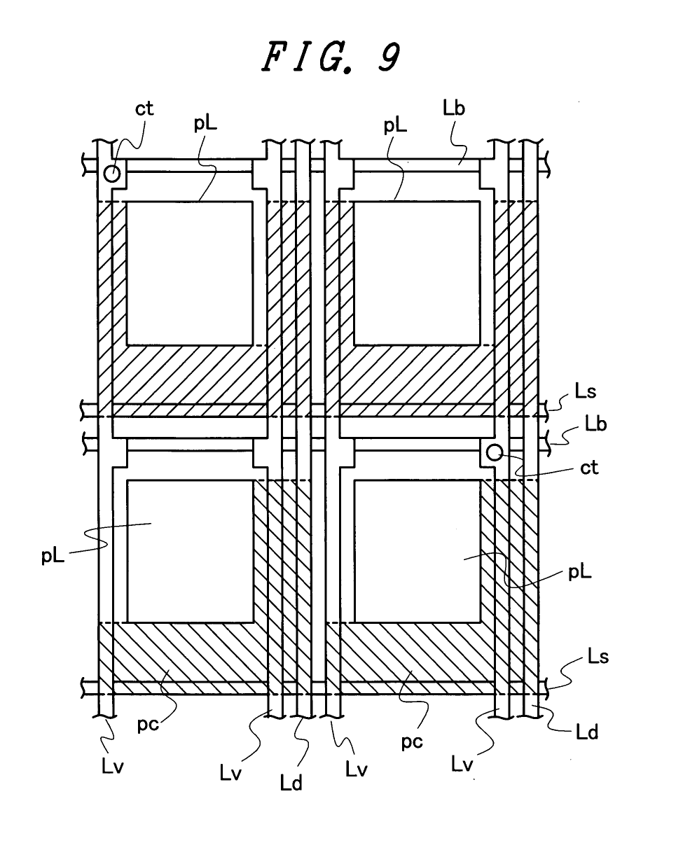

FIG. 8 is a plan view of an essential part of a display region for explaining an embodiment 7 of an organic EL display device according to the present invention. Further, FIG. 9 is an enlarged view showing neighboring four pixels of FIG. 8 for explaining an embodiment 7 of an organic EL display device according to the present invention. In the embodiment 7, a full-color display is expressed by four colors (sub pixels of R, G, B, W), and one color pixel is formed by arranging the sub pixels R, G, B, W in a two-row-two-column matrix. Also in this case, by connecting only the power source lines Lv of only one color to the bypass lines Lb in one row, it is possible to decrease the non-uniformity of brightness while suppressing the reduction of light from the light emitting portions pL. In case of the arrangement of the sub pixels R, G, B, W described in the embodiment 7, the bypass lines Lb are connected with the power source lines Lv of the sub pixels R, B, W, G in the order from above. Due to such a constitution, three or more contacts ct are not arranged continuously in the oblique direction and hence, a stripe in the oblique direction can be hardly observed.

The embodiment 2 and the embodiment 3 explained above have features in the line pattern, while the embodiment 4 and the embodiment 5 explained above have features in the alignment positions of the contacts. By combining the improvements due to the line pattern and the alignment position of the contacts, the stripe in the oblique direction can be made more invisible.

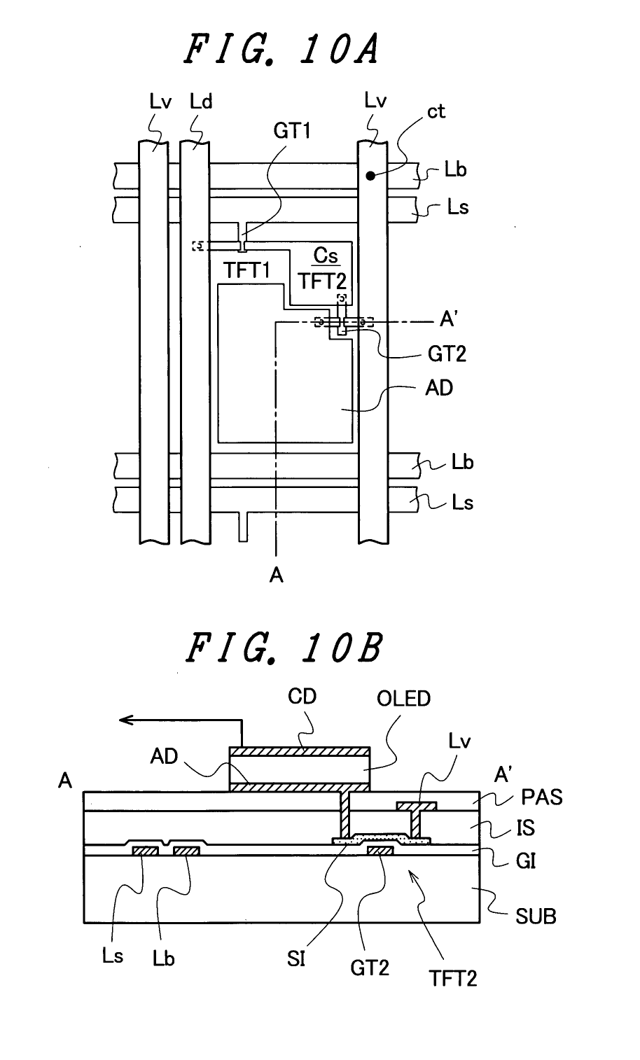

FIG. 10A and FIG. 10B are schematic views for explaining a pixel structural example of the organic EL display device according to the present invention, wherein FIG. 10A is a plan view, and FIG. 10B is a cross-sectional view taken along a line A-A′ in FIG. 10A. In this organic EL display device, scanning signal lines Ls are formed on an inner surface of a glass substrate SUB which constitutes a lower layer. Here, although a silicon oxide (SiO) film and a silicon nitride (SiN) film are formed as a background layer below the scanning signal lines Ls (on an inner surface of the glass substrate SUB), these films are not shown in the drawing. A gate electrode GT1 of a first thin film transistor TFT1 is formed on the scanning signal line Ls. The detailed structure of the gate electrode GT1 is omitted.

The bypass lines Lb and gate electrodes GT2 of second thin film transistors TFT2 are formed on the same layer as the scanning signal lines Ls. A gate insulation film GI is formed to cover the scanning signal lines Ls, the gate electrodes GT1 and the gate electrodes GT2. Active layers SI are formed on portions of the thin film transistors by patterning a silicon semiconductor layer. FIG. 10B shows the active layer SI of the second thin film transistor TFT2. An interlayer insulation layer IS is formed to cover the active layer SI.

Contact holes are formed in the interlayer insulation layer IS, and the power source lines Lv are connected with sources (or drains) of the second thin film transistors TFT2 via these contact holes and are formed in an intersecting manner with (here, orthogonal to) the scanning signal lines Ls and the bypass lines Lb. Further, a passivation film PAS is formed on the interlayer insulation layer IS. Contact holes which reach the drains (or the sources) of the second thin film transistors TFT2 after penetrating the passivation film PAS and the interlayer insulation layer IS are formed. An organic EL element OLED has one electrode (an anode here) AD thereof connected to the drain (or the source) of the second thin film transistor TFT2 via these contact holes.

A plurality of organic material layers which constitute the organic EL element are stacked on the anode AD, and a cathode CD which constitutes another electrode and is used in common by a plurality of pixels not shown in the drawing is formed over the organic EL elements. The cathode CD is connected to a ground or the like outside the display region. A protective film (not shown in the drawing) is formed on the cathode CD, and a sealing can (usually, a glass substrate) not shown in the drawing is arranged on or above the protective film.

The pixel (the sub pixel of the color pixel) is selected by the first thin film transistor TFT1 and stores the display data from the data signal line Ld in a holding capacitance Cs. With respect to the display data stored in the holding capacitance Cs, when the second thin film transistor TFT2 becomes conductive, an electric current supplied from the power source line Lv corresponding to a quantity of the display data is supplied to the organic EL element OLED from the anode AD. The organic EL element OLED emits light with brightness corresponding to an electric current which flows in the organic EL element OLED.

The power source lines Lv are in contact with the bypass lines Lb in the mode explained in any one of the above-mentioned embodiments. The contact portion is indicated by symbol ct. Here, when the organic EL material layer is formed by coating, a bank made of an insulation material is formed on a periphery of the organic EL element, and the organic EL material layer consisting of an electron injection layer, an electron transport layer, a light emitting layer and a hole transport layer is stacked in the bank. Here, there may be a case that a hole injection layer is formed on the hole transport layer.

In a top-emission-type organic EL display device which radiates light emitted from the organic EL element OLED toward a sealing can side, that is, toward an upper side in FIG. 10B from the cathode CD, the anode AD is formed of a reflective electrode made of a metal such as aluminum, and the cathode CD is formed of a transparent conductive film made of ITO or the like. In this case, it is unnecessary to take passing of the display light into consideration on a bottom side of the pixel, that is, on a glass-substrate-SUB side of the anode AD and hence, layout of a pixel circuit and lines can be performed with some degree of freedom. For example, all or some of the first and second thin film transistors TFT1, TFT2, the respective lines shown in FIG. 10A, the holding capacitance lines not shown in the drawing and the like may be arranged below the anode AD.

On the other hand, in the bottom-emission-type organic EL display device which radiates light emitted from the organic EL element OLED toward a glass-substrate-SUB side from the anode AD in FIG. 10B, the cathode CD is formed of a reflective electrode made of a metal such as aluminum and the anode AD is formed of a transparent conductive film made of ITO or the like.

In FIG. 10, the electrode closer to the glass substrate SUB is used as the anode AD, and the electrode remote from the glass substrate SUB is used as the cathode CD. However, it is needless to say that the anode AD and the cathode CD may be arranged in an opposite manner. Further, the thin film transistor adopts the structure which forms the gate electrodes on the glass substrate SUB and forms active layers on the gate electrodes. However, the display device which uses thin film transistors having the structure opposite to such structure may also fall within the scope of the present invention. Here, in all cases, the power source lines Lv and the bypass lines Lb are formed on layers different from each other by way of the interlayer insulation layer or other insulation layer, and the power source lines Lv and the bypass lines Lb are connected with each other via the contact holes formed in these insulation layers.

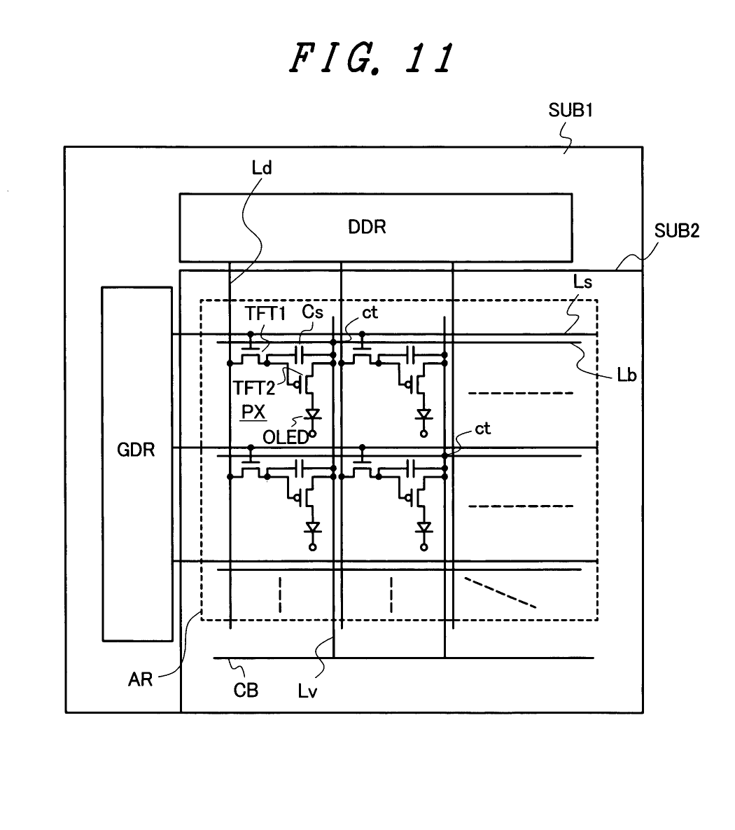

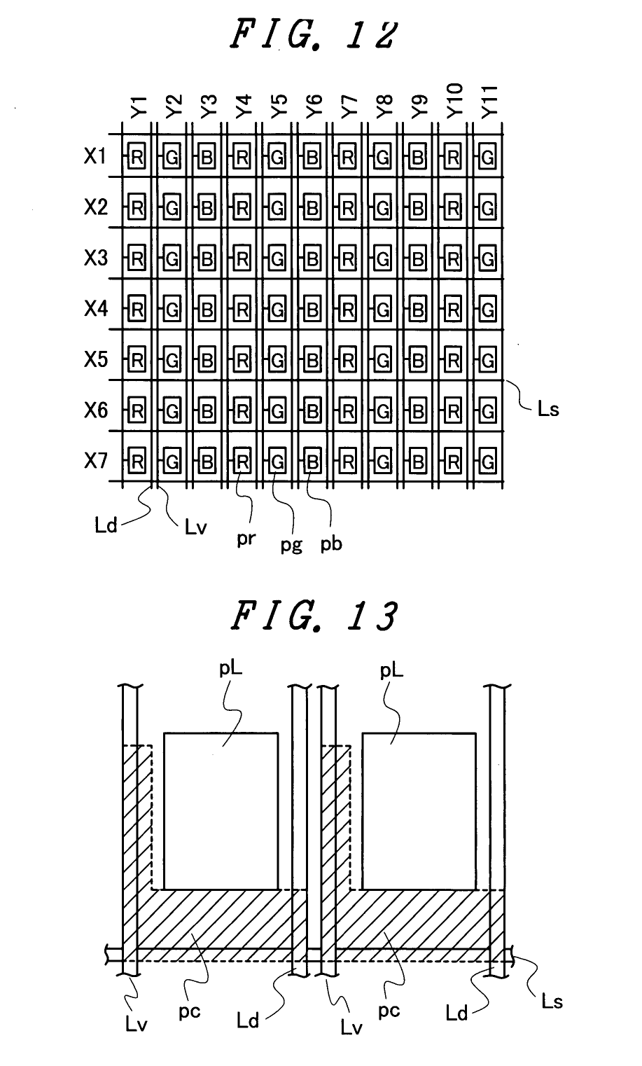

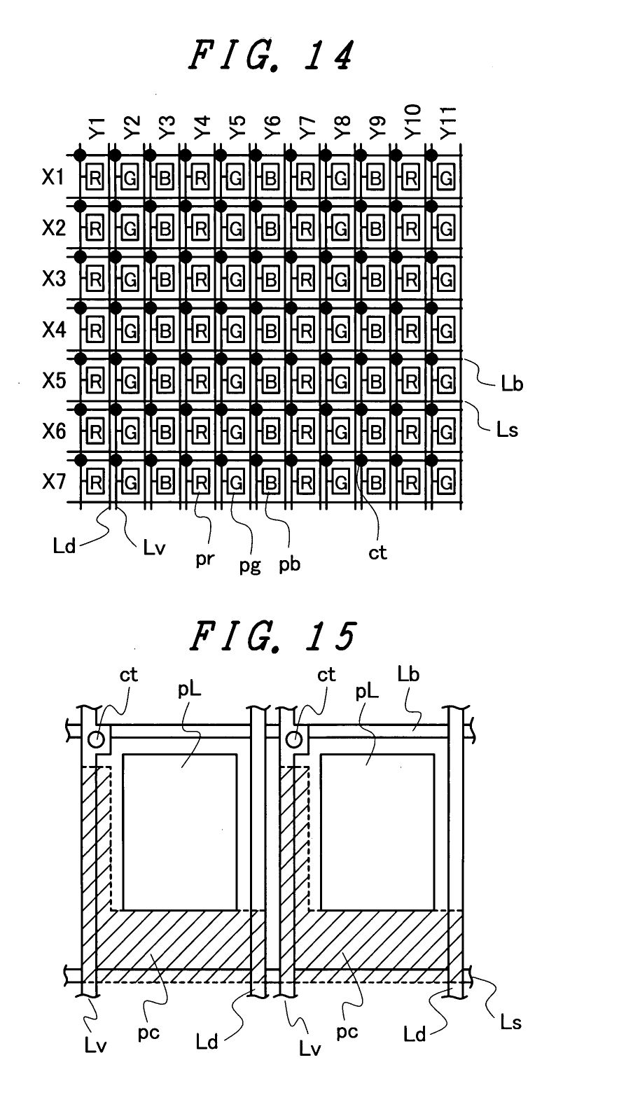

FIG. 11 is an equivalent circuit diagram for explaining an overall constitutional example of the organic EL display device according to the present invention. This constitution corresponds to the constitution of the above-mentioned embodiment 1. In FIG. 11, symbol px indicates the sub pixels (corresponding to pr, pg, pb in FIG. 1), and the color pixels each consisting of the sub pixels of three colors are arranged in a matrix array to form the display region AR. Each sub pixel PX is constituted of the first thin film transistor TFT1, the second thin film transistor TFT2, the holding capacitance Cs and the organic EL element OLED. In the display region, the data lines Ld, the scanning signal lines Ls, the power source lines Lv and the bypass line Lb are arranged. The power source lines Lv are connected with a power source bus line CB, the bypass lines Lb are arranged to intersect (usually orthogonally) the power source line Lv and, as shown in FIG. 1, the bypass lines Lb are connected with the power source lines Lv at predetermined positions of the sub pixels using the contacts ct.

The scanning signal lines Ls are driven by a scanning line drive circuit GDR and selects the row direction. Display data is supplied to the data lines connected to a plurality of pixels connected to the selected row from a data line drive circuit DDR, and a predetermined display is performed. The above-mentioned glass substrate SUB2 which constitutes the sealing substrate is arranged to cover the display region AR.

What is claimed is:

1. An organic EL display device comprising:
an insulation substrate having a display region in which color pixels are arranged in a matrix array and each one color pixel is constituted of a plurality of organic EL elements which constitute sub pixels and emit light different from each other; and
a transparent sealing substrate arranged to cover the display region, wherein
a plurality of scanning signal lines extending in one direction and arranged parallel to each other in another direction which intersects the one direction, a plurality of data signal lines extending in the another direction and arranged parallel to each other in the one direction, and a plurality of power source lines which are connected to the plurality of sub pixels and to which an electric current for display is supplied are arranged in the display region,
the sub pixels are arranged corresponding to intersecting portions of the scanning signal lines and the data signal lines,
the display region includes a plurality of power source bypass lines extending in the one direction and arranged parallel to each other in the another direction, and
one, two or more of the power source bypass lines are provided as lines for connecting the power source lines connected to the sub pixels of one color with each other.

2. An organic EL display device according to claim 1, wherein the pixel is formed of the sub pixels of red, green and blue, and
the bypass lines include the bypass lines which are connected with only the sub pixels of red, the bypass lines which are connected with only the sub pixels of green or the bypass lines which are connected with only the sub pixels of blue.

3. An organic EL display device according to claim 1, wherein the pixel includes sub pixels of white, and
the display device includes the bypass lines which are connected with only the sub pixels of white as the bypass lines.

4. An organic EL display device according to claim 1, wherein the bypass line is arranged between the scanning signal lines.

5. An organic EL display device according to claim 1, wherein a connection pattern formed on one or both of the power source bypass lines and the power source lines is provided to intersecting portions between the power source bypass lines and the power source lines.

6. An organic EL display device according to claim 5, wherein either one or both of a line width of the power source bypass line and a line width of the power source line is/are equal to or larger than a width of the connection pattern.

7. An organic EL display device according to claim 5, wherein the connection patterns includes connection patterns which do not contribute to the connection between the power source bypass lines and the power source lines.

8. An organic EL display device according to claim 5, wherein the connection patterns are not formed in the oblique linear direction on the matrix of the sub pixels.

9. An organic EL display device according to claim 1, wherein an interlayer insulation layer is formed between the power source bypass lines and the power source lines, and the power source bypass lines and the power source lines are connected with each other via contact holes formed in the interlayer insulation layer.

10. An organic EL display device according to claim 9, wherein the power source bypass lines are formed on the same layer as the scanning signal lines.
